(19) United States
(12) Patent Application Publication
(10) Pub. No.: US 2011/0046972 A1
(43) Pub. Date: Feb. 24, 2011

(54) METHOD AND SYSTEM FOR HEALTH-CENTERED MEDICINE

(75) Inventor: Jon Chris LEVERETTE, Orange Park, FL (US)

Correspondence Address: BUCHANAN, INGERSOLL & ROONEY PC, POST OFFICE BOX 1404, ALEXANDRIA, VA, 22313-1404, US

(73) Assignee: ANDROMEDA SYSTEMS INCORPORATED, Virginia Beach, VA (US)

(21) Appl. No.: 12/855,198

(22) Filed: Aug. 12, 2010

Related U.S. Application Data
(60) Provisional application No. 61/235,560, filed on Aug. 20, 2009.

(51) Int. Cl. G06Q 50/00; G06F 17/30

(52) U.S. Cl. 705/2; 707/705; 707/E17.044

(57) ABSTRACT

Methods and systems for personalized health plan are disclosed. The methods and systems determine a body system hierarchy corresponding to the patient that identifies elements of the patient's body and the associated functions of the elements, retrieve from a database of failures corresponding to the functions, determine risk factors of the patient for diseases corresponding the failures of the functions, select predetermined courses of action applicable to the plurality of diseases based on the determined cumulative risk, and provide a report including the selected courses of action for the patient.

This application claims the benefit of priority to U.S. Provisional patent application 61/235,560, filed on Aug. 20, 2009, the entire disclosure of which is hereby incorporated by reference into this specification.

### FIELD

The disclosed embodiments relate to acquiring, processing and analyzing medical information.

### BACKGROUND

To provide early-detection of diseases, healthcare providers may prescribe periodic screenings for a patient after he reaches a certain age. However, these early-detection procedures are not tailored to the particular patient. While a healthcare provider may adjust the schedule of the procedures given the patient's risk for a particular disease, the adjustments are largely based on empirical judgments. In addition, screenings are typically recommended based on broad guidelines that are directed at large populations and, as such, provide little or no guidance for atypical patients. For example, to detect colon cancer, colonoscopies may be recommended to begin at age fifty for an average patient and recur every five years thereafter. While this schedule may be modified if the patient falls into a high-risk category, the changes apply to anyone in the broad risk category.

### SUMMARY

Embodiments disclosed herein provide methods and systems that determine a personalized health plan for a patient. The disclosed methods and systems determine a body system hierarchy corresponding to the patient that identifies elements of the patient's body and the associated functions of the elements, retrieve from a database of failures corresponding to the functions, determine risk factors of the patient for diseases corresponding the failures of the functions, select predetermined courses of action applicable to the plurality of diseases based on the determined cumulative risk, and provide a report including the selected courses of action for the patient.

### BRIEF DESCRIPTION OF THE DRAWINGS

FIG. 1 is a block diagram illustrating an exemplary environment;

FIG. 2 is a block diagram illustrating an exemplary provider computer; and

FIG. 3 is a process flow chart illustrating exemplary steps performed by the provider computer.

### DETAILED DESCRIPTION

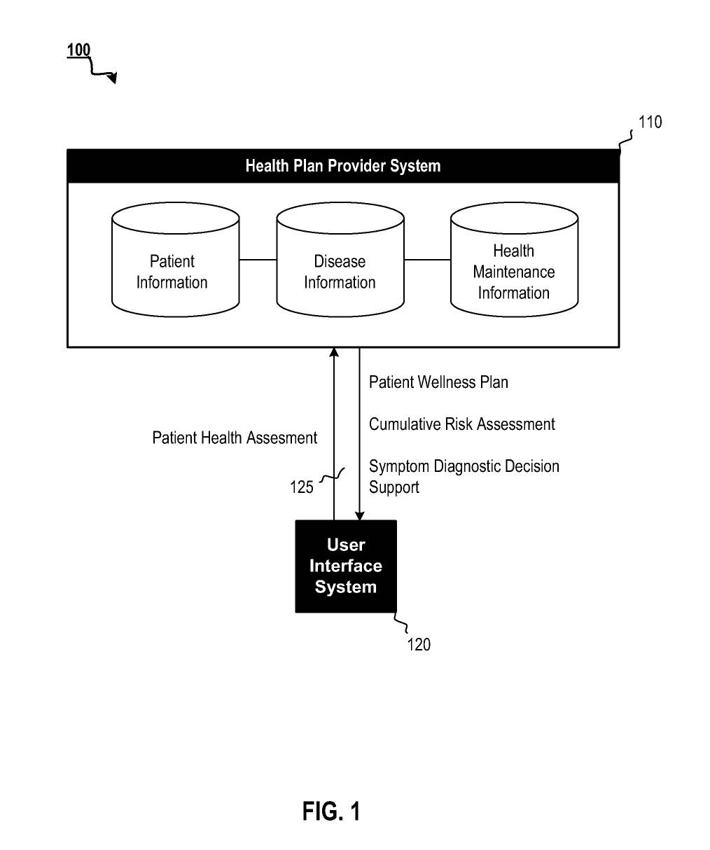

FIG. 1 is a block diagram illustrating an exemplary environment 100 in which the methods and systems of the present disclosure may be implemented. The environment 100 includes a health maintenance plan provider system 110 (“provider system”) communicatively coupled to a user interface system 120 via a communication link 125. The provider system 110 may be operated by a service which provides health maintenance plans that are tailored to particular patients.

A health maintenance plan is a document that indicates courses of action determined based on the patient's identified risk factors for one or more diseases. Additionally, the health maintenance plan may indicate sources of information to improve the courses of action identified in the plan.

The provider system 110 determines health maintenance plans based on patient information, disease information and health maintenance information. Patient information is information characterizing a patient. For example, the patient information may identify the patient's lifestyle, exercise habits, diet, medical history, socio-economic factors, living location, environment, heredity, family history, genetic markers and desired performance levels (e.g., competitive athlete, job requirements, etc.) In addition, patient information may define elements the patients' body system and their associated functions. Disease information may associate information on diseases with their corresponding risk factors, symptoms and effects. Health maintenance information includes courses of action identified to prevent, mitigate, or reduce the likelihood of the occurrence of corresponding diseases along with quantitative information on the actions' effectiveness, risks, costs, advantages and disadvantages of the respective techniques.

The user interface system 120 may be one or more devices through which a user may exchange information with the provider system 110 over the communication link 125. For instance, the user interface system 120 may be a personal computer, a television set-top box, a smart phone, a personal digital assistant, a telephone or a mobile phone. In addition, the user interface may be a medical monitoring device (e.g., weight, blood pressure, blood sugar, heart rate or alcohol monitor) or a location tracking device (e.g., a global positioning system device).

Users may be any individual or entity that provides or receives information to/from the provider system 110. A user may be, for example, a patient, a patient's family member, a healthcare provider (e.g., doctor, nurse, technician or caregiver), a hospital, an insurance provider, a data analytics provider, a data warehouse, a government agency or an educational institution.

The communication link 125 between the provider system 110 and the user interface may be a wired or wireless link that uses a variety of communication protocols. In some embodiments, the communication link 125 can be a direct connection, such as an analog, a serial or a parallel interface. In other embodiments, the communication link 125 may be a shared, public, private, or peer-to-peer network, encompassing any wide or local area network, such as an extranet, an intranet, the Internet, a Local Area Network (LAN), a Wide Area Network (WAN), a virtual private network (VPN), a voice over internet packet network (VoIP), a public switched telephone network (PSTN), an Integrated Services Digital Network (ISDN), or any other form of wired or wireless communication. Further, the communication link 125 can be compatible with any type of communications protocol used by the components of system environment 100 to exchange data, such as the Ethernet protocol, ATM protocol, Transmission Control/Internet Protocol (TCP/IP), Hypertext Transfer Protocol (HTTP), Hypertext Transfer Protocol Secure (HTTPS), or peer-to-peer protocol.

The environment illustrated in FIG. 1 is a simplified example having only one user interface system 120 and one provider system 110 connected by one communication link 125. The disclosed embodiments are not so limited and may include any number of systems that communicate over a variety of communication links and networks. In addition, some or all of the information illustrated in FIG. 1 as being included in the provider system 110 may located apart from the provider system 110 and accessed over additional communication links.

An exemplary interaction between the provider system 110 and the user interface system 120 of the environment 100 illustrated in FIG. 1 may occur as follows. A health assessment of a patient may be provided from a user (e.g., the patient, a doctor, a nurse, or a technician) to the provider system 110. The assessment may include, among other things, information about the patient's medical history, demographics, lifestyle, genetics, physiology, diseases and symptoms. While the assessment is described as a single document for the sake of simplicity, the assessment may be compiled from many documents (reports, tests, diagnoses, medical history, family history, etc.) that were generated at different times by different entities.

In some embodiments, the patient health assessment may be an electronic document provided via the user interface system 120. In other embodiments, the patient health assessment may be handwritten, typed or dictated, and then transcribed into an electronic document by the user interface system 120 and/or the health service provider system 110.

Using the information provided by the patient health assessment, the provider system 110 may populate one or more records of a patient profile, including information identifying functions of the patient's body system. Based on the identified functions, the provider system 110 determines diseases that may affect patient along with corresponding symptoms and effects of the diseases.

In addition, using the received patient information, the provider system 110 may determine the patient's personal risk factors for the diseases and identify corresponding courses of actions corresponding to the diseases. A cumulative risk of each disease may be determined based on the individual risk factors. An end-user, such as a doctor and/or the patient, may then select desired courses of action from the identified courses of action to prevent or mitigate the risks of the identified disease. Additionally or alternatively, the provider system 110 may select courses of action for the disease based on the benefits and costs stored in association with the corresponding courses of action.

Furthermore, the provider system 110 can provide decision support tools for maximizing efficacy, and/or minimizing risk, cost or other user defined parameters to help an individual select desired courses of action. These decision support tools may indicate impact of a selected course of action on discrete and overall risks and desired outcomes.

It should be noted that the exemplary embodiments disclosed herein are described in terms of humans. However, the systems and methods can be applied to livestock, zoo animals or any other living entity where a provider possesses knowledge of the entity's diseases and their corresponding symptoms, effects and courses of action.

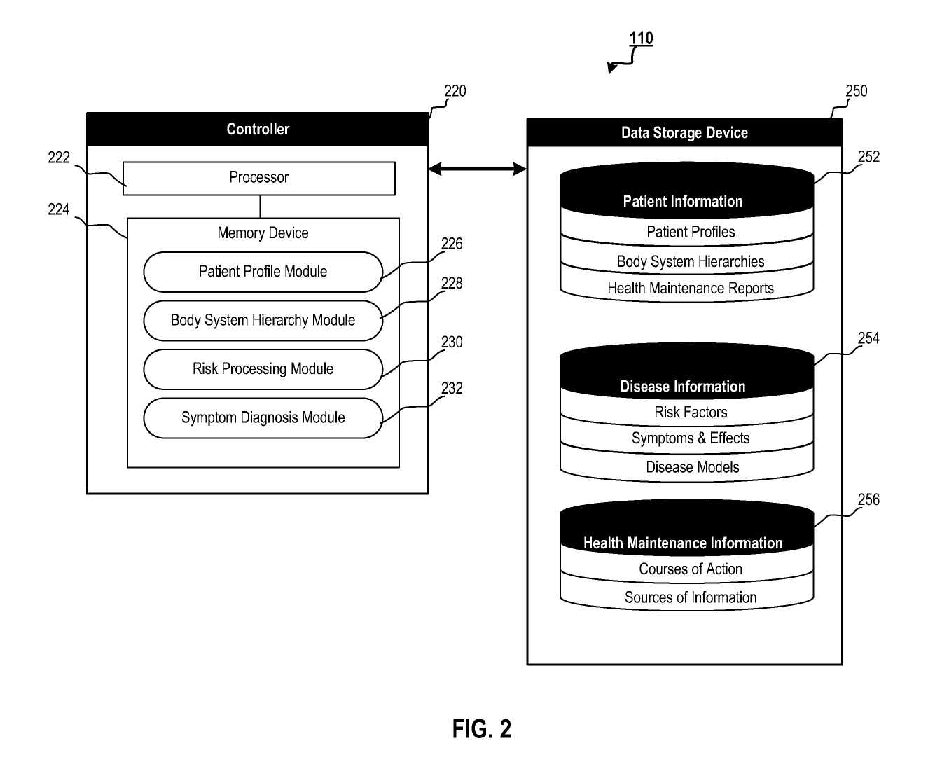

FIG. 2 is a block diagram of an exemplary provider system 110. The provider system 110 can be one or more devices for receiving, storing, and/or processing user information, and for providing health maintenance plans. The provider system 110 can be implemented as one or more information processing systems including, for example, a personal computer, a minicomputer, a microprocessor, a workstation, a server, a mainframe, or a combination thereof.

As shown, the provider system 110 may include controller 220 communicatively linked to a memory device 224 and data storage device 250. In addition, the controller 220 may include other components, such as a clock, a communication interface, a data bus, an input/output device, a user-input device and a display device (not shown). The processor 222 may be a general-purpose processor (e.g., INTEL or IBM), or a specialized, embedded processor (e.g., ARM).

Memory device 224 may be a random access memory (“RAM”), a read-only memory (“ROM”), a FLASH memory, or the like. Memory device 224 can store instructions that, when executed by the processor 222, configures the provider system 110 to be a special-purpose machine that performs the functions described herein.

The data storage device 250 may include any hardware, software, firmware, or combination thereof operable to store and retrieve information, including computer-readable program instructions and data. The data storage device 250 may be, for instance, a semiconductor, a magnetic or an optical-based information storage/retrieval device (e.g., flash memory, hard disk drive, CD-ROM, or flash RAM). Although the memory device 224 is depicted as a single medium, the device may comprise additional storage media devices.

The data storage device 250 may store computer-executable instructions (e.g., software, firmware, code, portions of code) and data (e.g., data compilations, databases, data set) that, when executed by the processor 222, control the provider system 110 to perform particular functions.

As shown in FIG. 2, the data storage device 250 may store databases of patient information, disease information and health maintenance information. The patient information database 252 may store information received about patients as well as information about the patient determined by the provider system 110. The patient information may include, patient profiles, body system hierarchies, and health maintenance reports.

A patient profile is information obtained by the provider about a patient from the patient's health assessment. The patient profiles may include records describing patient information corresponding to their operational context, functions, and associated desired standards of performance. For instance, the records may include information describing the environment an individual is subjected to (urban vs. rural, tropical vs. temperate, environmental toxins, etc.), lifestyle (diet, physical, vices, etc.), required performance levels (competitive athlete vs. office worker, etc.).

The patient information database 252 may also store body system hierarchies corresponding to particular patients. A body system hierarchy defines the physical relationships of the elements of the patient's body and associates the elements with corresponding functions. The hierarchy defines the relationships of systems, organs, and other elements, enable that diseases to be ascertained at every level of the hierarchy. Elements in a hierarchy can be further divided into lower level definitions identifying cells and parts of cells as necessary to identify the root cause of a disease.

Each body part described in the body hierarchy is associated with one or more functions and the context of those functions. A body part may have one or more primary functions and one or more secondary functions. A primary function is the is the basic function of a body part. For example, the lungs may have the primary function of transporting oxygen from the atmosphere into the bloodstream and to release carbon dioxide from the bloodstream into the atmosphere. A secondary function is tangential to the primary function. Exemplary categories of secondary functions may include: protection from foreign agents or harmful environments, aesthetics, sensing, body regulation and control. For example, the lungs also have the secondary functions of protecting from the inhalation of foreign agents and to contain liquids (blood) within the body. They also perform the secondary function of providing air to make sound. The term secondary is not intended to imply lesser importance. If the patient is a trumpet player, this secondary function is very important.

In addition, functions may be stored in association with corresponding contexts in which they are employed. For instance, the function of speaking is performed “on-demand,” whereas others, such as the heart pumping blood, regulated automatically, while still others such as breathing can be either. This information can help determine what courses of action are appropriate for failures of that function. An “on-demand” functions may be considered non-critical in a short period of time. For instance, a temporary failure to of the function speak due to laryngitis may not be critical. Conversely, improperly operating automatic functions may not be as recognizable to the person.

Functions may be stored in association with one or more corresponding functional failures. A functional failure is the inability of a body element to perform a function within specified limits. A functional failure may result in either reduced performance of some function, total loss of the use of a body system, loss of a body part or loss of life. For example, if a function of the lungs is “to provide oxygen from the atmosphere to the blood stream,” the function's failure may be “fails to provide oxygen from the atmosphere to the blood stream.”

Functional failures may include, for example, ways an individual can fail to meet desired performance levels (failure to perform at a competitive athletic level). Causes of functional failures are diseases. Failure effects may include symptoms as well as what happens to the individual due to the failure cause (death, loss of athletic performance, aesthetics, minor inconvenience, etc). The failure effects may include a standardized categorization of failure effects used for risk prioritization (for example a grouping of all conditions that may lead to death). When combined with a probability of occurrence, this provides a means to prioritize risk.

Disease information database 254 includes information defining diseases in association with corresponding disease risk factors and disease symptoms and effects. As used in this disclosure, a disease includes any condition, disease, sickness, infection, injury, damage, capacity reduction, or failure that affects a patient's physical or mental functions. A disease results from one or more failures and is characterized by one or more symptoms and/or effects. Physical diseases include, for example, conditions that cause reduction or failure in the function a part, organ, or system of a patient, including death. Mental diseases include conditions that impair patient's normal cognitive, emotional, or behavioral functioning. Normal medical conditions, such as pregnancy, would not be considered diseases.

Disease risk factors describe functional failures, causes of functional failures, failure effects and failure consequences. The risk factors for diseases can be compiled from sources such as, published health studies, medical literature, existing health industry databases, and subject matter experts. The risk factor information in the disease information database 254 includes each risk factor's documented effect on the risk of developing the disease, as well as its known relationship to the other risk factors. The data may then be compared to the risk factors identified in the patient health assessment to determine a patient's cumulative risk for each disease may be calculated and stored.

Symptoms are signs or indications of a disease, such as changes from normal function, sensation, perception or appearance. Symptoms of physical disease include damage, infection, physical defects, genetic defects or environmental stress. Symptoms of mental disease include, for example, social, psychological, biochemical, genetic, or other factors, such as infection or head trauma. A symptom may be felt or sensed by the patient or be latent unless detected by external means such as diagnostic tests. A symptom is not necessarily immediately identifiable to the disease. A symptom can be linked to several diseases, and most diseases have multiple symptoms. Therefore, symptoms and diseases have a “many to many” relationship. Effects are the results of the symptoms of a disease on the ultimate performance of the patient's body or mind. Effects may be marginal (inability to perform at optimal level), or severe (death).

The health maintenance information database 256 may include records identifying courses of action for predicting or preventing the diseases in the disease database. The courses of action may include any procedure performed to prevent or detect the onset of a disease based on an associated risk level. The courses of action include medical examination, testing or treatment at prescribed intervals and/or thresholds, for medical examinations, tests and procedures. In addition, courses of action include behavior modifications, such as diet and/or exercises regimens and the like. For example, a course of action may be a detective procedure at a fixed interval to detect a condition based on a calculated risk level. This course of action may include the identification of recurring intervals for specific procedures and onset threshold for those recurring procedures.

Examples of preventive courses of action are the regular consumption of specific protective nutritional supplements or medicines, applying vaccines, or adopting a prescriptive exercise regimen. In the case of a preventive task the application of a medicine is prior to the occurrence of a disease.

Predictive diagnostic courses of action are periodic procedures used to detect diseases in an early stage or to detect conditions that may indicate the onset of a disease. The intent of these courses of action are to identify a disease early enough to correct or mitigate its occurrence. Predictive diagnostics are used to identify directly related conditions that signal the onset of a disease such as using a colonoscopy to detect tumors in an early stage. Prognostics are used to predict the onset of a condition from one of more indirectly related or seemingly unrelated conditions. Example of prognostics may include monitoring blood cholesterol and sugar levels along with activity levels to predict the onset of heart disease.

Diagnostic courses of actions include actions to determine the root cause of a set of symptoms, for example an X-ray test to confirm a broken bone. Diagnostics differ from a predictive diagnostics and prognostics in that they are performed only to prove or disprove the existence of a known or unknown disease.

Pre-emptive courses of actions include actions that are taken to prevent or reduce or the probability of occurrence or to mitigate the severity of occurrence of a disease whether or not the condition exists at the time. These courses of action are usually only used where the risk of consequences of a disease is so high that the benefits of the courses of action outweigh its risks and costs. Examples of preemptive courses of action include the preemptive removal of an organ for an individual that has an exceptionally high risk of developing cancer in that organ.

Restorative courses of action include actions that are taken to stop, slow, correct, or reverse a disease once it is discovered. A restorative course of action may be applied as the result of finding a disease through another course of action of performed as a result of unexpected onset of a disease. Examples of restorative courses of action may include the removal of a tumor, prescribing chemotherapy, or performing a coronary bypass surgery.

Failure detection courses of action include tests or procedures to detect latent defects or conditions that do not progress on their own but are dependent on a second independent condition or circumstance to manifest. For example, such tests would detect a misshaped heart valve that would only become evident if the individual having the condition was subjected to physical conditions outside of normal. An example might include a person having an atrial septal defect (ASD) who takes up SCUBA diving. This defect may go unnoticed forever with no risk except that in the SCUBA diving environment it could prove fatal.

Living context courses of action include any other measures that can be used to reduce the probability of occurrence or mitigate the severity of diseases. Examples of living context courses of actions include changing the environment an individual is subjected to or lifestyle changes such as quitting smoking.

The course of action information may also include one-time strategies for preventing failures or conditions. These can be actions taken to change the risk level for a particular condition. Examples include: a decision to change the environment for an asthma patient from a tropical to an arid location; the decision to preemptively remove an organ highly likely to develop a specific cancer based on individual risk factors; or diet change based on specific risk factors.

Turning back to the provider system 110, FIG. 2 illustrates the memory device 224 storing program modules that, when executed by processor 222 of the controller 220, control the provider system 110 to perform particular functions described below. The program modules include a patient profile module 226, a body system hierarchy module 228, a risk processing module 230 and a symptom diagnosis module 232. Additionally, although not shown, the memory device 224 may include other computer-executable instructions that control a communication server (e.g., a bootloader, an operating system, control modules, hardware drivers, codecs, user interfaces, applications, network browsers, etc.)

The patient profile module 226, when executed by the processor 222, controls the provider system 110 to receive information of a patient and store the information in one or more records that comprise a patient profile. As shown in FIG. 1, provider system 110 may receive a patient health assessment from the user interface system 120. The patient profile module 226 may transcribe, abstract and/or extract information from the health assessment using processes known in the art and store the patient's information in records of the patient information database 252. Such methods are described in U.S. Patent Application Publication No. 2004/0243545 to Boone et al, published on Dec. 2, 2004, the entire contents of which is incorporated herein by reference.

The body system hierarchy module 228, when executed by the processor 222, controls the provider system 110 to determine a body system hierarchy for a particular patient based on the patient's profile. As detailed above, the body system hierarchy identifies elements of the patient's body and the associated functions of the elements. The hierarchy may be based on predefined templates stored in the data storage device 250 that associate baseline functions and other information with, for example, different races, genders, ages and/or other demographics.

The risk processing module 230, when executed by the processor 222, controls the provider system 110 to determine a customized risk profile for the according to patient profile and identified risk factors. The risk processing module 230 may retrieve failures corresponding to said functions from the patient information database 252. In addition, the risk processing module 230 may retrieve from the disease information database 254 risks of diseases corresponding to the functional failures in the body hierarchy. The risk processing module 230 may determine a cumulative risk profile for the patient using the retrieved risks. The risk factor information in the disease information database 256 indicates the risk of developing a disease, as well as its known relationship to the other risk factors. The risk processing module 230 compares the risk factors identified in the patient health assessment and calculates the cumulative risk for each disease.

The symptom diagnosis module 232 determines applicable courses of action from the health maintenance information database 256 for the diseases to identify recommended courses of action to prevent, mitigate, or reduce the likelihood of the occurrence of specific diseases. There are several types of courses of action which may or may not be applicable to a given disease. The relevance of a course of action category to a particular disease is dependent on the characteristics of the disease. For example, a prognostic test will not detect random events, such as broken arms, before they occur. The health maintenance plan tailors recommendations for courses of action to each individual based on their particular risk factors.

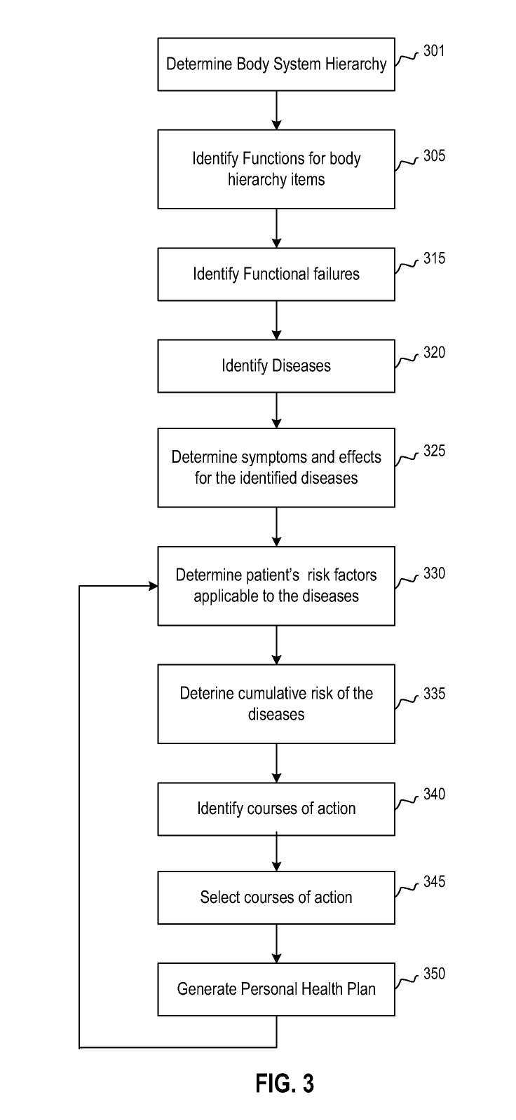

FIG. 3 illustrates an exemplary method for providing health maintenance plans. A body system hierarchy identifying elements of the patient's body and the associated functions of the elements for a particular patient is determined based on information stored in a patient profile within the patient information database 252. (Step 301.) In some embodiments, the patient profile module 226 may determine the body system hierarchy based on predefined templates. The provider system 110 may retrieve a template based on the template's similarity to a particular patient. For example, the provider system 110 may retrieve a template corresponding to an individual patient's race, nationality, gender, age or any combination thereof.

Functions corresponding to the elements in the body system hierarchy are identified. (Step 305.) The patient profile module 226 identifies some or all of the functions associated with the elements of the hierarchy by the predefined template. Functions can be added to or removed from the body system hierarchy based on to the patient data. For instance, for an amputee, functions of the right leg, such as jumping, may be removed, and functions, such as mating with prosthesis, could be added.

In some embodiments, the patient profile module 226 may present the body system hierarchy on a graphic user interface using text and/or graphics. Each element of the hierarchy could be linked to its associated functions such that a user may select each element, review and, if appropriate for the patient, modify the element and its associated function. Additionally, the patient profile module 226 could automatically change or recommend changes to the particular elements based information associated with the information when it was abstracted extracted from personal assessment and stored in the database. For instance, if a user selects a leg element in the patient's body system hierarchy, the graphic user interface may provide a menu of items associated with the term “leg.” Such information may be presented for any element at any level of the hierarchy.

Failures corresponding to the functions in the body system hierarchy are retrieved from the patient information database 252. (Step 315.) For the functions included in the body system hierarchy, the risk processing module 230 may retrieve failures that are stored in association with the functions. In addition, a user may add or remove functional failures that are not accounted for in the predefined template. For instance, for an amputee, an additional function may be “leg fails to mate with prosthesis” or any other failure that may not be associated with a typical patient's body system hierarchy. That is, a user may manually enter failures corresponding to functions based on their specialized knowledge. Additionally or alternatively, the risk processing module 230 may retrieve failures associated in the disease information database 254 with one or more functions. The retrieved failures may be automatically mapped to the functions and/or displayed for the user on the graphic user interface for selection and/or confirmation.

For the identified functional failures, corresponding diseases that may cause the failures are identified. (Step 320.) The risk processing module 230 may retrieve functional failures in the disease information database 254 that are related with one or more diseases that may result from the failures' occurrence. As such, a particular disease may identify several times for a single patient based on different functional failures associated with the patient's body system hierarchy.

Symptoms and effects are retrieved by the risk processing module 230 for each of the identified diseases in the disease information database 254. (Step 325.) The disease information database 254 may also include probabilities of occurrence of symptoms with corresponding diseases. Accordingly, the risk processing module 230 associates each potential symptom and effect for a given disease with that disease. The diagnosis module 232 compares symptoms and related risk factors to determine potential diseases for a given symptom set. The list may be ranked based on in their associated risks. Risks may be determined based on personal health information and risk factor information and by applying analytical models to determine a cumulative risk “score” for diseases, as applied to each individual.

The risk processing module 230 determines the patient's risks of the diseases corresponding to the functional failures in the body hierarchy. (Step 330.) To make this determination, all known significant risk factors for each disease are considered. In addition, the factors' relationships and compounding effects are accounted for in order to correctly interpret and calculate the patient's personal risk.

Using the identified risk factors, a cumulative risk of disease may be determined by the risk processing module 230. (Step 335.) If all risk factors are assumed to be independent, the cumulative risk for a given disease may be defined by:

$$Rcum = {\sum }_{k = 1}^{n} {R}_{k} ,$$

where R is the independent risk from each risk factor, n is the number of independent risk factors that have been identified in a risk profile that is associated with that disease.

Where risk factors are not independent, a combined risk for the dependent risk factors can be determined for any remaining independent risk factors. The risk processing module 230 may determine the combined risk using one or more analytical procedures such as correlation analyses, factorial analyses, Design of Experiments (DOE), and statistical processes. In some embodiments, the risk processing module 230 identifies and evaluates all risk factors through the use of data models that will be unique to each disease.

Based on the determined cumulative risk, courses of action may be selected from the courses of action in the heath maintenance information database 256. The symptom diagnosis module 232 may identify courses of action for the identified disease. (Step 340.) This step identifies all applicable courses of actions in the health maintenance information database 256 that may prevent or mitigate the identified dieses. Different courses of action may be stored by the health maintenance information database 256 in association with different probabilities of affecting a disease. Applicable courses of action includes a description of the courses of action, the frequency of application, dosage if applicable, reduction in risk of the disease from the courses of action, any increased risk of other side effects, conditions, or diseases from the courses of action, and potential positive and negative interactions with other courses of action.

Courses of action may be selected based on a quantitative assessment of a patient's risk for a specific disease and the actions expected benefit to reduce and/or avoid the final result of that disease (e.g., loss of function). (Step 345.) The symptom diagnosis module 232 may provide parameters for a user to select the desired courses of action for each disease. For example, the selected courses of action maybe ranked based on their associated costs and risks. The selection can be made in a preventive role if a disease is not being experienced or in a treatment role if a disease does exist. The diagnosis module 232 provides information to a user for evaluating the merits and risks of various treatment options, as well as to suggest additional wellness options, not to replace the advice of the physician. Furthermore, the diagnosis module 232 may provide decision support parameters for the selection of courses of action and allow the selection to be made on factors such as: the probability of successful outcome, physician and patient preferences, treatment risks/side effects, other treatment consequences (quality of life, inconvenience), availability, feasibility, convenience, and/or treatment cost.

Based on the patient information, disease information and course of action information, the diagnosis module 232 may provide a patient health report to a user via the user interface system 120 or some other means of communication. (Step 350.) The report may include, for example, a patient wellness plan, a cumulative risk assessment and diagnostic decisions support information.

Users may monitor and update the plan over time as life facts and circumstances change. The monitoring effort may include manual updates of the patient health assessment as life circumstances change and it may include the collection of data in a manual or automated fashion that can automatically calculate changes to risk factors. Sensors such as pedometers, blood pressure meters, heart rate monitors, and blood sugar meters can be used to automatically or manual collect data as part of an integrated health monitoring system that provides data that, along with document changes to the patient health assessment and living context will provide the ability to refine risk and monitor the effectiveness of a wellness program.

The following provides an exemplary scenario for providing a health report to a patient whose vocation is competitive running. As such, the patient's health maintenance report will include the patient's particular lifestyle information and its functional requirements. Similar to the exemplary embodiments discussed above, the provider may receive a health assessment for the patient that indicates the patient's vocation and that, in this example, requires him to run twenty-five miles per week. Information may be extracted from the personal assessment and recorded in the patient's profile. The patient profile may, of course, include information from other sources, such as previous health information of the patient and/or the patient's family (e.g., assessments, health maintenance reports, examinations, evaluations, diagnoses, history, procedures, surgeries, medications, etc.).

The provider system 110 may encode information in the assessment using various known techniques. In cases where the assessment is a dictation or a physical document, for example, the information may be transcribed into a computer-readable document either manually by a human (e.g., a transcriber) and/or automatically by a computer (e.g., provider system 110).

Once the assessment is encoded in a computer-readable document, relevant information may be extracted and stored in the patient's profile. In some embodiments, the extraction is automated using known abstraction and normalization methods to identify relevant words and combinations of words within the document, and to encode the information within one or more records having a standardized format.

Based on the information stored in the patient's profile, the patient profile module 226 may determine a body system hierarchy for the patient along with associated functions of the elements in the hierarchy. As noted above, the patient profile may be based on a template having standard elements and functions for an individual similar to the patient that is modified to represent the patient's required function. That is, the patient's musculoskeletal system may include the function of running twenty-five miles per week. Additionally, other systems, such as the cardiovascular and respiratory systems, may be modified accordingly to account for the requirements of the runner's given vocation.

In addition to standard functions for the patient's systems, the standard (i.e., baseline) values may be modified to represent the runner's particular functions. For instance, there may be baseline values associated with body functions that are relevant to running, such as height, weight, body fat, blood pressure, heart rate and/or blood volume, to name a few. The provider system 110 may store such values obtained from medical journals and the like. These baseline values may be modified by the provider to be representative of the current patient using research information obtained from studies of competitive runners, for example.

Based on the identified body functions, the risk processing module 230 identifies potential failures of the functions. For the runner, one failure may simply be an inability to run twenty-five miles per week. Of course, other potential failures will exist for this and other functions of the runner.

Diseases corresponding to the hierarchy that may affect the patient are then identified. Diseases relevant to the runner may include, for example, inflammation and/or fractures in parts of the hips, legs and feet.

Symptoms and effects are then determined for each of the identified diseases. In this case, symptoms corresponding the effect of inability to run twenty-five miles per week may include, muscle or joint pain, foot pain, shortness of breath, dizziness and seeing spots, to name a few. These symptoms may be retrieved from a set of symptoms stored in the disease information database 254. Alternatively, the symptoms may be identified by a doctor or medical technician based on their personal expertise. The risk processing module 230 associates each potential symptom for a given disease with that disease. For instance, shin splints may be associated with pain in the tibia.

The provider system 110 then determines the patient's personal risk factors for the identified diseases. Risk factors may be determined from baseline information. For instance, a typical individual may not run and, thus, have essentially zero chance of developing shin splints. However, the disease information database 254 may store information that individuals who run more than twenty miles a week have an 80% chance of developing shin splints. The probability may be obtained from existing medical references, studies, and databases and from the future assessment of data collected by and stored in the disease information database 254.

The patient's risk for shin splints may be modified and/or combined with other risk factors for the disease. For instance, the patient may run barefoot. Research information may indicate that barefoot runners have an increased risk of developing shin splints. Other research may indicate that barefoot runners who run more than ten miles a week have a 95% chance of developing shin splints. Based on the different risk factors, the patient's particular risk factor may be determined by combining the different risks associated with the particular patient.

Different courses of action may be identified for addressing the patient's risk of shin splints. The course of action for shin splints may be retrieved from the course of action database. For example, courses of action for shin splints may include: wear training shoes that provide additional padding; seeking coaching advice to improve running technique; reduce training frequency; train on different surface (e.g., grass, treadmill); stopping training. The provider may select different courses of action for the patient. The provider system 110 may generate a personal health plan for the patient which includes the selected courses of action.

As disclosed herein, embodiments and features can be implemented through computer hardware and/or software. Such embodiments can be implemented in various environments, such as networked and computing-based environments with one or more users. The disclosed embodiments, however, are not limited to such examples, and the embodiments can be implemented with other platforms and in other environments.

Other embodiments of the invention will be apparent to those skilled in the art from consideration of the specification and practice of the embodiments of the invention disclosed herein. Further, the steps of the disclosed methods can be modified in any manner, including by reordering steps and/or inserting or deleting steps, without departing from the principles of the invention. It is therefore intended that the specification and embodiments be considered as exemplary only.

What is claimed is:

1. A system for providing a personalized heath plan, said system comprising:
a processor;
a memory device;
a patient information database;
a disease information database; and
a course of action database;
wherein the memory device stores program instructions that, when executed by the processor, control the system to:
determine a body system hierarchy corresponding to a particular patient, the body system hierarchy identifying elements of the patient's body and the associated functions of the elements;
retrieve from the patient information database a plurality of failures corresponding to said functions;
retrieve from the disease information database a risk of a disease corresponding to one or more of the plurality of failures of said functions in the body hierarchy;
select, based on the risk, a course of action from the course of action database; and
provide a report including the selected course of action for the patient.

2. The system of claim 1, wherein said risk is based on a patient profile.

3. The system of claim 1, wherein the program instructions, when executed by the processor, control the system to retrieve from the disease database symptoms corresponding to the disease.

4. The system of claim 1, wherein:
the disease database identifies a correspondence between symptoms and diseases; and
the risk is based on symptoms of the patient.

5. The system of claim 1, wherein the program instructions, when executed by the processor, control the system to determine the risk of the disease based on plurality of risk factors associated with a plurality of functions.

6. The system of claim 1, wherein the program instructions, when executed by the processor, control the system to rank the courses of action based on associated costs and risks.

7. The system of claim 1, wherein the report indicates one or more of the following: courses of action, a description of the courses of action, the frequency of application of the courses of action, dosage, reduction in risk of the disease from the courses of action, side effects from the courses of action, and potential positive and negative interactions with other courses of action.

8. A method for providing a personalized heath plan, said method comprising:
determining a body system hierarchy corresponding to a particular patient, the body system hierarchy identifying elements of the patient's body and the associated functions of the elements;
retrieving from a patient information database a plurality of failures corresponding to said functions;
retrieve from a disease information database a risk of a disease corresponding to one or more of the plurality of failures of said functions in the body hierarchy;
selecting by the processor, based on the risk, a courses of action from a course of action database; and
providing a report including the selected course of action for the patient.

9. The method of claim 8, wherein said risk is based on a patient profile.

10. The method of claim 8, wherein determining the risk includes retrieving from a disease database symptoms associate with the plurality of diseases.

11. The method of claim 8, wherein retrieving the risk includes, retrieving from the disease database symptoms corresponding to the disease.

12. The method of claim 8, wherein the determining the risk for the plurality of diseases includes determining the risk of the disease based on plurality of risk factors associated with a plurality of functions.

13. The method of claim 8, wherein selecting the courses of action includes ranking the courses of action based on associated costs and risks.

14. The method of claim 8, wherein the report indicates one or more of the following: courses of action, a description of the courses of action, the frequency of application of the courses of action, dosage, reduction in risk of the disease from the courses of action, side effects from the courses of action, and potential positive and negative interactions with other courses of action.

15. A computer-readable storage device storing program instructions for providing a personalized heath plan that, when executed by a processor, controls a computer to:
determine a body system hierarchy corresponding to a particular patient, the body system hierarchy identifying elements of the patient's body and the associated functions of the elements;
retrieve from a patient information database a plurality of failures corresponding to said functions;
retrieve from a disease information database a risk of a disease corresponding to one or more of the plurality of failures of said functions in the body hierarchy;
select, based on the risk, a course of action from a course of action database; and
provide a report including the selected course of action for the patient.

16. The computer-readable medium of claim 15, wherein said risk is based on a patient profile.

17. The computer-readable medium of claim 15, wherein retrieving the risk includes, retrieving from the disease database symptoms corresponding to the disease.

18. The computer-readable medium of claim 15:
the disease database identifies a correspondence between symptoms and diseases; and
the risk is based on symptoms of the patient.

19. The computer-readable medium of claim 15, wherein the determining the risk for the plurality of diseases includes determining the risk of the disease based on plurality of risk factors associated with a plurality of functions.

20. The computer-readable medium of claim 15, wherein selecting the courses of action includes ranking the courses of action based on associated costs and risks.

21. The computer-readable medium of claim 15, wherein the report indicates one or more of the following: courses of action, a description of the courses of action, the frequency of application of the courses of action, dosage, reduction in risk of the disease from the courses of action, side effects from the courses of action, and potential positive and negative interactions with other courses of action.
